(19) United States
(12) Patent Application Publication
(10) Pub. No.: US 2026/0158733 A1
(43) Pub. Date: Jun. 11, 2026

(54) LAMINATE FILM MANUFACTURING METHOD

(71) Applicant: TOYOTA JIDOSHA KABUSHIKI KAISHA, Toyota-shi (JP)

(72) Inventor: Satoshi NAKASHIMA, Toyota-shi (JP)

(73) Assignee: TOYOTA JIDOSHA KABUSHIKI KAISHA, Toyota-shi (JP)

(21) Appl. No.: 19/179,014

(22) Filed: Apr. 15, 2025

(30) Foreign Application Priority Data
Aug. 22, 2024 (JP) 2024-141099

(51) Int. Cl. B29C 51/12; B29C 51/08; B29L 31/34

(52) U.S. Cl. CPC B29C 51/12; B29C 51/082; B29L 2031/3468

(57) ABSTRACT

The method for manufacturing a laminate film according to the present disclosure is a manufacturing method in which a forming device is used. The manufacturing method includes: forming a recess in the laminate film using an adjustment mechanism by pressing a tip of a punch against the laminate film placed on a die; welding, using a heater provided in the die, a spacer disposed on a corner of the tip of the punch to a corner of the recess formed in the laminate film; and moving the tip of the punch away from the die using the adjustment mechanism, and separating the spacer welded to the laminate film from the corner of the tip of the punch.

### CROSS-REFERENCE TO RELATED APPLICATION

This application claims priority to Japanese Patent Application No. 2024-141099 filed on Aug. 22, 2024. The disclosure of the above-identified application, including the specification, drawings, and claims, is incorporated by reference herein in its entirety.

### BACKGROUND

### 1. Technical Field

The present disclosure relates to a laminate film manufacturing method.

### 2. Description of Related Art

Japanese Unexamined Patent Application Publication No. 2004-039271 (JP 2004-039271 A) discloses a technique for a method of manufacturing a storage battery module. The method allows reducing wrinkling of a laminate film when the pressure on the laminate film is reduced. Specifically, in JP 2004-039271 A, when a power generating element is sealed by laminate films with their peripheral surfaces facing each other joined, insulating spacers are disposed on the insides of corners of a recess of one of the laminate films such that the spacers fill the spaces between the corners of the recess and the corners of the power generating element that face the corners of the recess. With the spacers, the shape of the recess is retained when sealing is performed using the laminate films under a reduced pressure, so that wrinkling on the corners of the laminate film is reduced.

### SUMMARY

In the technique disclosed in JP 2004-039271 A, the spacers are disposed on the insides of the corners of the recess of the laminate film that houses the power generating element by hand or by using equipment, such as a transfer hand.

In recent years, storage batteries with high capacity and high density for vehicles including battery electric vehicles (BEV) have been in demand, and development of large storage battery modules has been in progress to achieve efficient storage batteries. As the size of storage battery modules increases, when spacers are disposed according to the technique in JP 2004-039271 A using equipment, such as a transfer hand, clearances are produced between the corners of the recess of the laminate film and the spacers because of the influence of assembly accuracy, tolerances in the forming, and part tolerances. This caused an issue of wrinkling in the laminate film when the pressure was reduced.

It is a purpose of the present disclosure to provide a laminate film manufacturing method by which wrinkling in a laminate film is reduced when sealing is performed using the laminate film under a reduced pressure.

A laminate film manufacturing method according to the present disclosure is a laminate film manufacturing method in which a forming device is used. The forming device includes a die on which a laminate film is placed, a punch that presses a tip of the punch against the laminate film placed on the die to form a recess in the laminate film, an adjustment mechanism that adjusts a relative position between the die and the punch, a spacer disposed in a portion including a corner of the tip of the punch, and a heater disposed in the die. The laminate film manufacturing method includes: forming the recess in the laminate film by pressing the tip of the punch against the laminate film using the adjustment mechanism, the laminate film being placed on the die; welding, using the heater, the spacer disposed on the corner of the tip of the punch to a corner of the recess formed in the laminate film; and moving the tip of the punch away from the die using the adjustment mechanism, and separating the spacer welded to the laminate film from the corner of the tip of the punch.

Moreover, in the laminate film manufacturing method according to the present disclosure, a spacer is disposed in a side portion including the corner of the tip of the punch.

Moreover, in the laminate film manufacturing method according to the present disclosure, the spacer is disposed in the corner of the tip of the punch.

Moreover, in the laminate film manufacturing method according to the present disclosure, the spacer is disposed in a peripheral portion including the corner of the tip of the punch.

The present disclosure makes it possible to provide a laminate film manufacturing method that can reduce wrinkling in the laminate film when sealing is performed using the laminate film under a reduced pressure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view illustrating an example of a configuration of a forming device according to a first embodiment;

FIG. 2 is a perspective view illustrating an example of a tip of a punch of the forming device according to the first embodiment;

FIG. 3 is a diagram illustrating the relationship between the positions of heaters provided in a recess of a die of the forming device according to the first embodiment and the positions of spacers when the spacers reach the bottom dead center;

FIG. 4 is a diagram illustrating an example of the operation of the forming device according to the first embodiment;

FIG. 5A is a diagram illustrating a laminate film formed by the forming device according to the first embodiment;

FIG. 5B is a diagram illustrating the laminate film formed by the forming device according to the first embodiment;

FIG. 5C is a diagram illustrating the laminate film formed by the forming device according to the first embodiment;

FIG. 6A is a perspective view illustrating an example of the tip of the punch of the forming device according to a modification of the first embodiment; and

FIG. 6B is a perspective view illustrating an example of the tip of the punch of the forming device according to another modification of the first embodiment.

### DETAILED DESCRIPTION OF EMBODIMENTS

An embodiment of the present disclosure will be described in detail below with reference to the drawings. In each drawing, the same or corresponding elements are given the same reference signs, and duplicated descriptions are omitted as necessary for clarity of explanation.

### First Embodiment

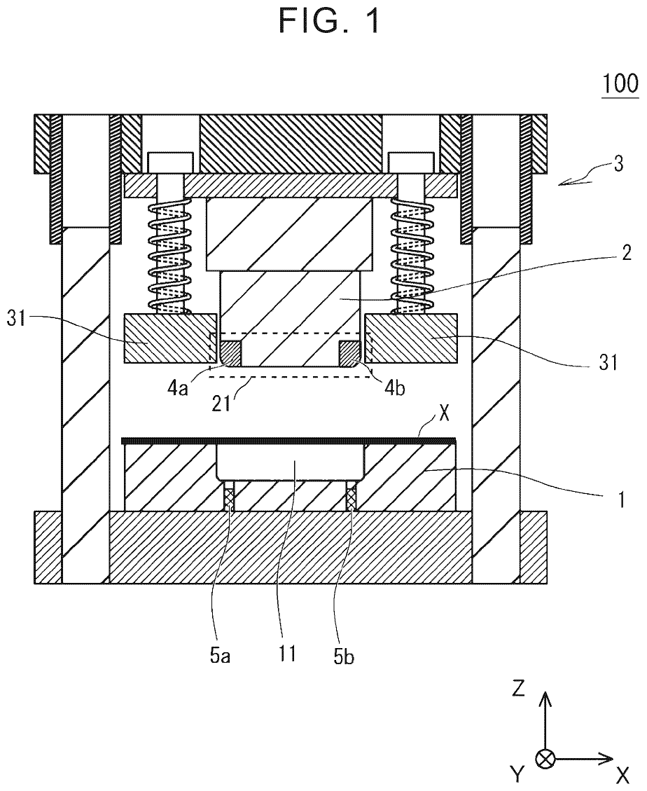

First, a configuration of a forming device 100 according to a first embodiment will be described with reference to FIG. 1. FIG. 1 is a side view illustrating an example of the configuration of the forming device 100 according to the first embodiment.

As shown in FIG. 1, the forming device 100 is a device for forming a laminate film X. The laminate film X is an exterior body for housing a power generating element and spacers of a storage battery module. The laminate film X is a film having a laminate structure in which a metal layer and a resin layer are laminated together. For example, the laminate film X is a metal laminate film in which resin layers are provided on both sides of a metal layer. The metal layer is made of, for example, aluminum foil. The resin layers on the both sides are made of, for example, PP, PET, or nylon. In order to facilitate welding (described later) to spacers 4a, 4b, portions of the laminate film X to which the spacers 4a, 4b are welded are or the entirety of the laminate film X is preferably made of a resin (such as PP) having a relatively low melting point. The thickness of the laminate film X is preferably 50 μm to 500 μm.

The forming device 100 includes a die 1, a punch 2, an adjustment mechanism 3, the spacers 4a, 4b, and heaters 5a, 5b. The die 1 is a member on which the laminate film X is placed. The punch 2 is a member for forming a recess in the laminate film X by pressing a tip 21 against the laminate film X placed on the die 1. The tip 21 of the punch 2 is inserted into a recess 11 provided in the die 1.

The spacers 4a, 4b are members to be attached to the corners of the recess to be formed in the laminate film X by the tip 21 of the punch 2. The spacers 4a, 4b are made of resins, such as PE, PP, PVC, ABS, and PET, which are classified as general-purpose plastics, and POM, PEEK, PPS, and PTFE resins, which are classified as engineering plastics or super engineering plastics. The spacers 4a, 4b may be made of a combination of a plurality of resins. The spacers 4a, 4b may be made of a material to which a reinforcing material, such as glass fiber or carbon fiber, is added in order to suppress warping and to reduce the difference in linear expansion coefficient with the laminate film X. In order to facilitate welding (described later) to the laminate film X, portions of the spacers 4a, 4b to which the laminate film X is welded are or the entirety of the spacers 4a, 4b is preferably made of a resin (such as PP) having a relatively low melting point.

The spacers 4a, 4b are disposed on the tip 21 of the punch 2. For example, the spacers 4a, 4b are suctioned onto the tip 21 of the punch 2 using suction portions (not shown) provided on the tip 21 of the punch 2 so as not to fall. The punch 2 may be provided at its tip 21 with gripping portions (not shown) for gripping the spacers 4a, 4b, instead of the suction portions (not shown).

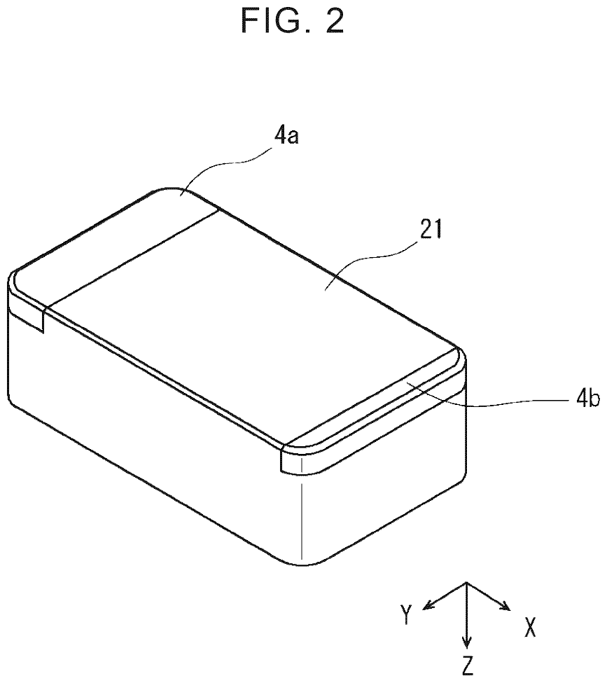

The specific shape and layout position of each of the spacers 4a, 4b are shown in FIG. 2. FIG. 2 is a perspective view illustrating an example of the tip 21 of the punch 2 of the forming device 100 according to the first embodiment. As shown in FIG. 2, the spacers 4a, 4b are disposed in portions including corners of the tip 21 of the punch 2. More specifically, the tip 21 of the punch 2 has four corners. The spacer 4a is disposed on a side portion including two corners of the tip 21 of the punch 2 on another side (negative x direction side). The spacer 4b is disposed on a side portion including two corners of the tip 21 of the punch 2 on one side (positive x direction side). The number of corners of the tip 21 of the punch 2 is not limited to four and can be changed. The number and shape of the spacers 4a, 4b can be changed depending on the number of corners of the tip 21 of the punch 2.

The adjustment mechanism 3 adjusts the relative positions of the die 1 and the punch 2. Specifically, the adjustment mechanism 3 raises or lowers the punch 2. Here, the position of the laminate film X when the laminate film X pressed by the tip 21 of the punch 2 reaches the bottom surface of the recess 11 of the die 1 is the bottom dead center of the tip 21 of the punch 2 and the spacers 4a, 4b. The adjustment mechanism 3 is provided with strippers 31 that hold the laminate film X when the tip 21 of the punch 2 is pressed against the laminate film X during the downward movement of the punch 2.

The heaters 5a, 5b are devices for welding the corners of a recess formed in the laminate film X by the tip 21 of the punch 2 to the spacers 4a, 4b disposed on the tip 21 of the punch 2. The heaters 5a, 5b are disposed in the recess 11 of the die 1.

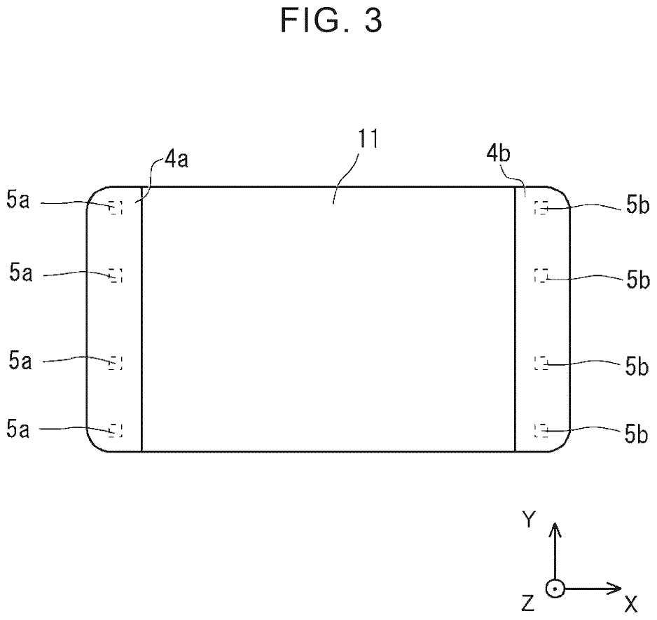

The specific layout of the heaters 5a, 5b is shown in FIG. 3. FIG. 3 is a diagram illustrating the relationship between the positions of the heaters 5a, 5b provided in the recess 11 of the die 1 of the forming device 100 according to the first embodiment and the positions of the spacers 4a, 4b when the spacers 4a, 4b reach the bottom dead center. FIG. 3 is also a diagram illustrating the relationship between the positions of the heaters 5a, 5b and the spacers 4a, 4b when the positions are viewed from an upper side in the vertical direction (positive z direction side) in FIG. 1.

As shown in FIG. 3, one or more (four in the embodiment) heaters 5a are provided near the bottom dead center of the spacer 4a in the bottom surface of the recess 11 of the die 1. Similarly to the heaters 5a, one or more (four in the embodiment) heaters 5b are provided near the bottom dead center of the spacer 4b in the bottom surface of the recess 11 of the die 1. Here, the heaters 5a, 5b are preferably disposed in the bottom surface near the corners of the recess 11 of the die 1. The configuration of the heaters 5a, 5b is not limited to the example shown in FIG. 3. For example, the heaters 5a, 5b are not limited to being disposed in the bottom surface of the recess 11 of the die 1, and may be disposed in side surfaces of the recess 11 of the die 1. The heaters 5a, 5b may be moved upward and downward by cylinders etc. instead of being fixed to the bottom surface of the recess 11 of the die 1. Moreover, the number, length, and welding shape of the heaters 5a, 5b can also be changed.

The forming device 100 includes a computer (not shown) that includes a processor and a memory. The processor may be, for example, a microprocessor, a micro processing unit (MPU), or a central processing unit (CPU). The processor may include a plurality of processors. The memory is made of a combination of a volatile memory and a non-volatile memory. The memory may include a storage disposed remote from the processor. In this case, the processor may access the memory via an I/O interface, not shown. The processor executes one or more programs including a set of instructions for the adjustment mechanism 3, the heaters 5a, 5b, the suction portions, etc. The program includes a set of instructions (or software codes) for causing the computer to perform one or more functions described in the embodiment when the program is loaded into the computer. The program may be stored in a non-transitory computer-readable medium or a tangible storage medium. By way of example and not limitation, the computer-readable medium or the tangible storage medium includes: random-access memory (RAM), read-only memory (ROM), flash memory, solid-state drive (SSD), or other memory technology; CD-ROM, digital versatile disc (DVD), Blu-ray (registered trademark) disk, or other optical disk storage; and magnetic cassette, magnetic tape, magnetic disk storage, or other magnetic storage devices. The program may be transmitted on a transitory computer-readable medium or a communication medium. By way of example and not limitation, the transitory computer-readable medium or the communication medium includes electrical, optical, acoustic signals, or other form of propagation signals.

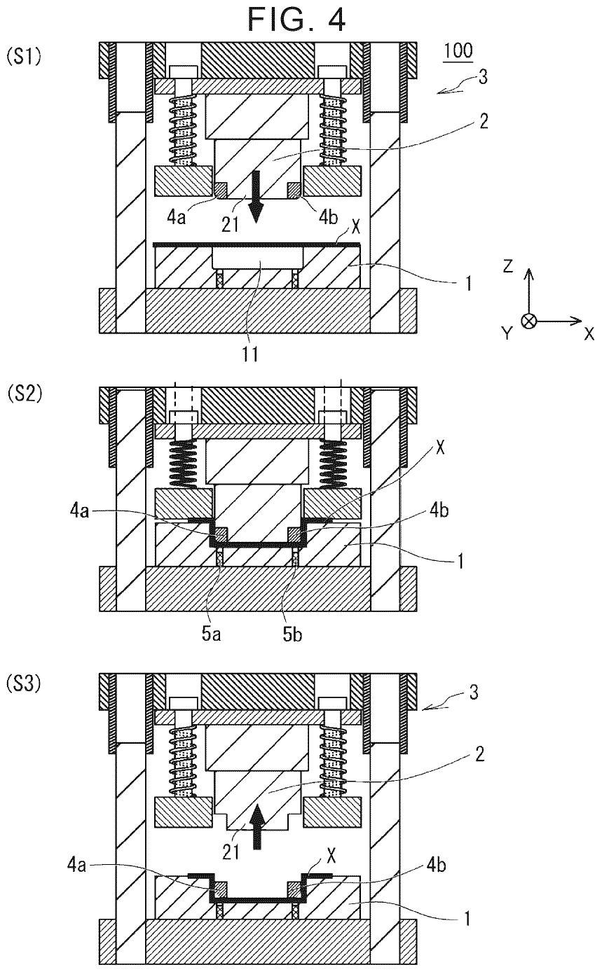

Next, the operation of the forming device 100 according to the first embodiment will be described with reference to FIG. 4. FIG. 4 is a diagram illustrating an example of the operation of the forming device 100 according to the first embodiment (i.e., a method of manufacturing the laminate film X).

Before step S1, the spacers 4a, 4b are disposed on the tip 21 of the punch 2 of the forming device 100. Specifically, the forming device 100 starts suction of the spacers 4a, 4b onto the tip 21 of the punch 2 using the suction portions.

Next, in step S1, using the adjustment mechanism 3, the forming device 100 lowers the tip 21 of the punch 2 and presses the tip 21 of the punch 2 against the laminate film X placed on the die 1. By doing so, the forming device 100 forms a recess in the laminate film X.

Next, in step S2, the forming device 100 welds, using the heaters 5a, 5b, the corners of the recess formed in the laminate film X to the spacers 4a, 4b disposed on the tip 21 of the punch 2. Welding conditions are, for example, a welding temperature of 200° C. and a welding time of 15 s when the welding surfaces of the spacers 4 a, 4 b and the laminate film X are both made of PP and the thickness of the laminate film X is about 150 μm. When the welding temperature is 230° C., the welding time is about 5 s.

Next, in step S3, the forming device 100 moves the tip 21 of the punch 2 away from the recess 11 of the die 1 using the adjustment mechanism 3, thereby separating the spacers 4a, 4b welded to the laminate film X from the corners of the tip 21 of the punch 2. For example, at a predetermined timing after step S1, the forming device 100 stops suction of the spacers 4a, 4b onto the tip 21 of the punch 2 using the suction portions. By doing so, in step S3 the forming device 100 moves the tip 21 of the punch 2 away from the recess 11 of the die 1 using the adjustment mechanism 3, thereby separating the spacers 4a, 4b welded to the laminate film X from the corners of the tip 21 of the punch 2.

In step S3, the laminate film X is eventually stuck to the recess 11 of the die 1. However, depending on the draft angles of the recess 11 of the die 1 and the tip 21 of the punch 2, after the adjustment mechanism 3 moves the tip 21 of the punch 2 away from the recess 11 of the die 1, the laminate film X may be stuck to the tip 21 of the punch 2. In this case, in step S3, the adjustment mechanism 3 moves the tip 21 of the punch 2 away from the recess 11 of the die 1, and then the suction portions stop suction of the spacers 4a, 4b onto the tip 21 of the punch 2.

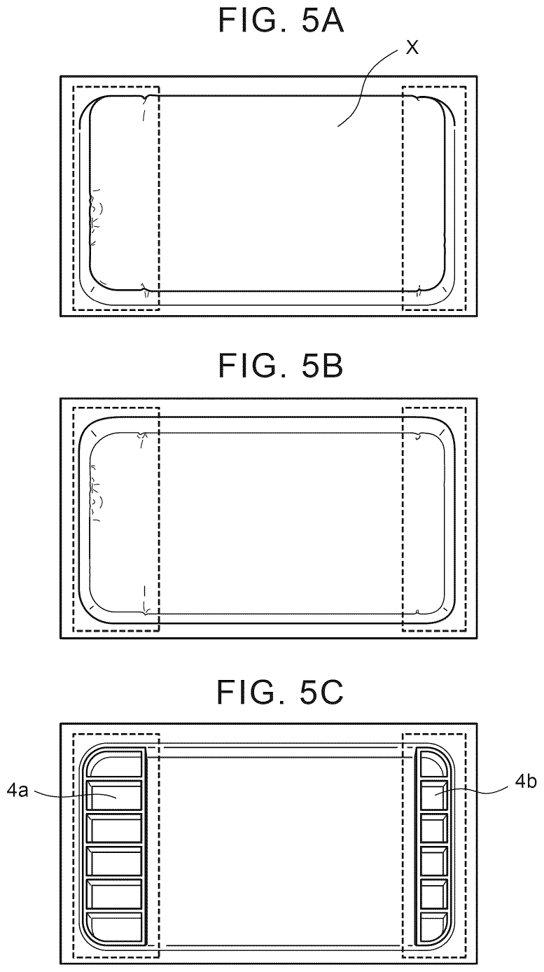

FIGS. 5A, 5B, and 5C are each a diagram illustrating the laminate film X formed by the forming device 100 according to the first embodiment. FIG. 5A is the diagram illustrating the rear side (the projecting side) of the formed recess of the laminate film X with the spacers 4a, 4b removed. FIG. 5B is the diagram illustrating the front side of the laminate film X in FIG. 5A. FIG. 5C is the diagram illustrating the formed recess of the laminate film X with the spacers 4a, 4b welded to the recess. Note that in FIGS. 5A and 5B, the spacers 4a, 4b are not welded.

As shown in FIGS. 5A and 5B, in the portion where the spacer 4a has been removed from the formed laminate film X (within the area surrounded by the dotted line), the surface roughness of the spacer 4a is reflected, so that a wrinkle-like pattern that is the shape of the spacer 4a is transferred. Moreover, a step at the connection between the spacer 4a and the tip 21 of the punch 2 is also transferred to the portion. The same applies to the portion where the spacer 4b has been removed from the formed laminate film X. Accordingly, this shows that the laminate film X is formed to conform to the shapes of the spacers 4a, 4b.

The configuration and operation of the forming device 100 according to the first embodiment have been described above. When spacers are placed on the corners of the recess of the laminate film using equipment, such as a transfer hand, as in the manufacturing method of JP 2004-039271 A, clearances will be produced between the corners of the recess of the laminate film and the spacers because of the influence of assembly accuracy, tolerances in the forming, and part tolerances.

However, in the method of manufacturing the laminate film X in which the forming device 100 is used according to the first embodiment, the laminate film X is formed using the very spacers 4a, 4b disposed on the tip 21 of the punch 2. Accordingly, in the manufacturing method, the shapes of the corners of the formed recess of the laminate film X conform to the shapes of the spacers 4a, 4b. Therefore, the manufacturing method can suppress clearances from being produced between the corners of the recess of the laminate film X and the spacers 4a, 4b, and reduce wrinkling in the laminate film X when sealing is performed using the laminate film X under a reduced pressure. In the manufacturing method, the spacers 4a, 4b are welded to the laminate film X. Therefore, the manufacturing method can suppress clearances from being produced between the corners of the recess of the laminate film X and the spacers 4a, 4b due to misalignment of the spacers 4a, 4b, and reduce wrinkling in the laminate film X when sealing is performed using the laminate film X under a reduced pressure.

### Modifications of First Embodiment

In the above first embodiment, the spacers 4a, 4b are disposed on the tip 21 of the punch 2 of the forming device 100 (see FIGS. 1 and 2). The shapes of the spacers 4a, 4b are not limited to the example.

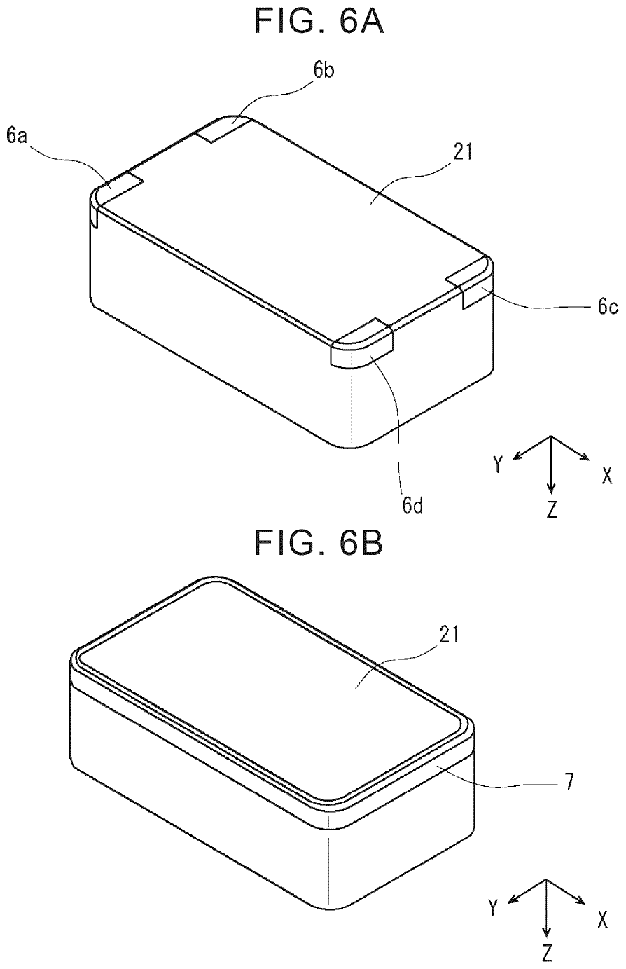

FIGS. 6A and 6B are each a perspective view illustrating an example of the tip 21 of the punch 2 of the forming device 100 according to a modification of the first embodiment. FIG. 6A is the perspective view of the tip 21 of the punch 2 of the forming device 100 according to the modification of the first embodiment. As shown in FIG. 6A, spacers 6a, 6b, 6c, 6d are disposed on the four corners of the tip 21 of the punch 2, in place of the spacers 4a, 4b. FIG. 6B is the perspective view of the tip 21 of the punch 2 of the forming device 100 according to another modification of the first embodiment. As shown in FIG. 6B, a spacer 7 is disposed in a peripheral portion including the four corners of the tip 21 of the punch 2, in place of the spacers 4a, 4b. The number of the corners of the tip 21 of the punch 2 is not limited to four and can be changed. The numbers and shapes of the spacers 6a, 6b, 6c, 6d, and the spacer 7 can be changed depending on the number of corners of the tip 21 of the punch 2. Furthermore, the positions and number of the heaters 5a, 5b in the first embodiment described above may be appropriately changed according to the shapes of the spacers 6a, 6b, 6c, 6d, and the spacer 7.

Furthermore, as shown in FIGS. 2, 6A, and 6B, the surface shapes of the spacers 4a, 4b, the spacers 6a, 6b, 6c, 6d, and the spacer 7 of the forming device 100, in particular the shapes (e.g., patterns) of the surfaces pressed against the laminate film X, are not limited to the above embodiment and may be set individually. By making the surfaces of the spacers 4a, 4b that are pressed against the laminate film X have a distinctive shape, it becomes easier to detect infringement.

As shown in FIG. 1, in the forming device 100 of the above embodiment, the punch 2 is disposed above the die 1. However, in the forming device 100 according to the modifications, the punch 2 may be disposed below the die 1 by turning each of the punch 2 and the die 1 upside down.

Although the present disclosure has been described above with reference to the embodiment, the present disclosure is not limited to the embodiment. Various modifications that would be understood by a person skilled in the art can be made to the configuration and details of the present disclosure within the scope of the present disclosure. Moreover, each embodiment can be appropriately combined with other embodiments.

Each of the drawings is merely an example for purposes of illustrating one or more embodiments. Each of the drawings is not related to one particular embodiment, and may be related to one or more other embodiments. As will be understood by a person skilled in the art, various features or steps described with reference to any one drawing may be combined with features or steps shown in one or more other drawings to produce, for example, an embodiment not explicitly shown or described. Not all of the features or steps illustrated in any one of the drawings are necessary to describe an exemplary embodiment, and some features or steps may be omitted. The order of steps depicted in any of the drawings may be rearranged as appropriate.

What is claimed is:

1. A laminate film manufacturing method in which a forming device is used, the forming device including
a die on which a laminate film is placed,
a punch that presses a tip of the punch against the laminate film placed on the die to form a recess in the laminate film,
an adjustment mechanism that adjusts a relative position between the die and the punch,
a spacer disposed in a portion including a corner of the tip of the punch, and
a heater disposed in the die, the laminate film manufacturing method comprising:
forming the recess in the laminate film by pressing the tip of the punch against the laminate film using the adjustment mechanism, the laminate film being placed on the die;
welding, using the heater, the spacer disposed on the corner of the tip of the punch to a corner of the recess formed in the laminate film; and
moving the tip of the punch away from the die using the adjustment mechanism, and separating the spacer welded to the laminate film from the corner of the tip of the punch.

2. The laminate film manufacturing method according to claim 1, wherein the spacer is disposed in a side portion including the corner of the tip of the punch.

3. The laminate film manufacturing method according to claim 1, wherein the spacer is disposed in the corner of the tip of the punch.

4. The laminate film manufacturing method according to claim 1, wherein the spacer is disposed in a peripheral portion including the corner of the tip of the punch.
